(19) United States
(12) Patent Application Publication
(10) Pub. No.: US 2010/0289272 A1
(43) Pub. Date: Nov. 18, 2010

(54) Method of Extension of the Regulation Range of Electric Power Supplied to the Electricity Grid and an Energy System with an Extended Regulation Range

(76) Inventor: Zdenek Funda, Vodnany (CZ)

Correspondence Address: NOTARO, MICHALOS & ZACCARIA P.C., 100 DUTCH HILL ROAD, ORANGEBURG, NY, 10962, US

(21) Appl. No.: 12/681,471

(22) PCT Filed: Sep. 24, 2008
(86) PCT No.: PCT/CZ08/00114

§ 371 Date: Aug. 4, 2010

(30) Foreign Application Priority Data
Oct. 4, 2007 (SK) PP 5117-2007

(51) Int. Cl. F02D 29/06

(52) U.S. Cl. 290/40 B

(57) ABSTRACT

The present invention deals with a method and energy system of extension of the electric power regulation range in which electricity produced by an electricity or electricity and heat production source can be supplied in the place of connection to the electricity grid, wherein the regulation range of the source is limited by the maximum installed electric output at the top and the minimum electric output of the source at which it is still possible to operate the source in a stable way at the bottom. According to the invention, before the place of connection to the electricity grid, an electric appliance is installed to the source that will reduce the electric output in the place of connection to the electricity grid below the minimum electric output of the source through its own consumption in the case of demand, extending thus the regulation range of the electric output that can be supplied to the electricity grid in the place of connection as compared to the regulation range of the source alone.

### TECHNICAL FIELD

This invention deals with a method of extension of the regulation range of electric power supplied to the electricity grid and an energy system with an extended regulation range.

### BACKGROUND ART

One of the biggest problems related to the use of electricity is the impossibility to store it in the original form of energy. Therefore at any moment the balance between the production and consumption of electricity must be maintained. In every electricity grid this is the responsibility of the system operator, who procures supporting services from power plants and heat plants. A supporting service means the possibility of a source of electricity to very quickly respond to the system operator's request for a change of output.

For the purposes of this application power plants and heat plants are also referred to as “sources” in the text of the present patent application.

Supporting services can only be provided by certain types of sources. E.g. nuclear power plants do not usually provide them, or in a minimum scope. Supporting services are provided to a greater extent by heat plants and power plants producing electricity and heat from coal or gas. However, the range of the provision of supporting services is limited by the installed output of the source at the top and the minimum technical output at the bottom. The minimum technical output means the output at which the source can still be operated in a stable way. In the case of some sources this range is additionally limited by the obligation to supply heat.

The reason for the impossibility to reduce the output of a heat source for the production of electricity by simply reducing the output of the turbine is a certain regulation range of the operation of the turbine and steam boilers where the turbine and boiler can be operated. Moreover, in case of high consumption of heat from extraction condensation turbines the high forced production of electricity in the high-pressure part of the turbine before the extraction is caused by the high flow that must be achieved for the purpose of the heat supply through the high-pressure part of the turbine and heat extraction by the consumer. The steam turbine can be shut down and the heat supply accomplished with the use of reduction of steam (throttling and cooling with high parameters—pressure and temperature) produced in the boilers. However, in case of turbine shutdown its re-start is time-consuming and it shortens its life and causes considerable losses related to the start-up from the shut-down condition to the required output.

The production of heat delivered to end customers is ensured in most sources producing heat and electricity by burning of fuel and production of steam in a boiler. Steam with high parameters of pressure and temperature passes through a steam turbine, when after doing the work and production of electricity it leaves the turbine and can be used for the production of heat for end customers in a heat exchanger. The level when steam from the turbine is extracted for the production of heat depends on the particular location and technological layout of the heat plant. In principle, just a part of the steam may be extracted and the rest may continue e.g. to the condensation part (extraction turbine) or all the steam passing through the turbine may be extracted (back-pressure turbine). Hot or warm water used as the heat energy medium for end customers usually leaves the heat exchanger. From the customers cooled water returns and it is heated in the heat exchanger to the output temperature by steam again and flows to the end customers. During the production of electricity in the turbine there is a certain minimum limit of its permanently sustainable output and this limit of minimum output of the turbine is mostly increased by the requirement for heat supply from the turbine outlet. In case of a requirement to reduce the output of the turbine for the needs of power regulation this reduction may get to the level below the minimum output of the turbine; however, just the operation range of the turbine resulting from its technical capabilities may be used, which is moreover influenced by forced production of electricity due to heat supplies (forced increase of production of the combined production mode).

The need of a higher range of regulation of the electricity grid has been growing in the recent years. One of the causes is the increase of the installed output in the wind power plants the operation of which depends on climatic conditions and the possibility of prediction of their operation is minimal. As the above mentioned facts show, the disadvantage of the existing electricity production sources is their insufficient ability to change the range of the electric power supplied to the grid while maintaining stable operation of the source and without the need to destroy a part of the produced electricity.

The aim of the present invention is to suggest a method allowing an extension of the regulation range of electric power supplied to the electricity grid and an energy system with an extended regulation range.

### SUMMARY OF THE INVENTION

The aims of the invention are fulfilled by the method of extension of the electric power regulation range in which electricity produced by an electricity source or electricity and heat production source can be supplied in the place of connection to the electricity grid, where the regulation range of the source is limited by the maximum installed electric output at the top and the minimum electric output of the source at which it is still possible to operate the source in a stable way at the bottom, wherein the substance of the method consists is that before the place of connection to the electricity grid an electric appliance is connected to the source which electric appliance will reduce the electric output in the place of connection to the electricity grid below the minimum electric output of the source through its own consumption if needed, extending the regulation range of the electric output that can be supplied to the electricity grid in the place of connection as compared to the regulation range of the source alone.

As the electric appliance an electric heater of heat-carrying media can be advantageously installed.

An electric water heater can be beneficially connected to the steam heat exchanger designed to heat heating water with steam while in case of a requirement to reduce the electric output in the place of connection to the electricity grid below the minimum electric output of the source heating water will be heated in the electric water heater.

In the electric water heater at least a part of returned cooled water from the customer or customers may be heated before it enters the steam exchanger. Another solution is that in the electric heater at least a part of water flowing to the customer or customers from the steam heat exchanger is additionally heated. Both these alternatives can also be combined.

The aims of the invention are also fulfilled by an energy system with an extended electric power regulation range in which electricity produced by an electricity or electricity and heat production source can be supplied in the place of connection to the electricity grid, where the regulation range of the source is limited by the maximum installed electric output at the top and the minimum electric output of the source at which it is still possible to operate the source in a stable way at the bottom, wherein the substance of the energy system consists in that it comprises an electric appliance connected to the source before the place of connection to the electricity grid.

As the electric appliance an electric heater of heat-carrying media can be advantageously used.

According to another beneficial embodiment an electric water heater that heats water if it is necessary to reduce the electric output in the place of connection to the electricity grid below the minimum output of the source is connected to the heat exchanger of the source designed to heat heating water by steam.

The electric water heater may be designed to heat at least a part of returned water from the heat consumer(s) before it enters the steam heat exchanger or to additionally heat at least a part of water flowing from the heat exchanger to the heat consumer(s) while both these alternatives can also be combined.

### BRIEF DESCRIPTION OF THE DRAWINGS

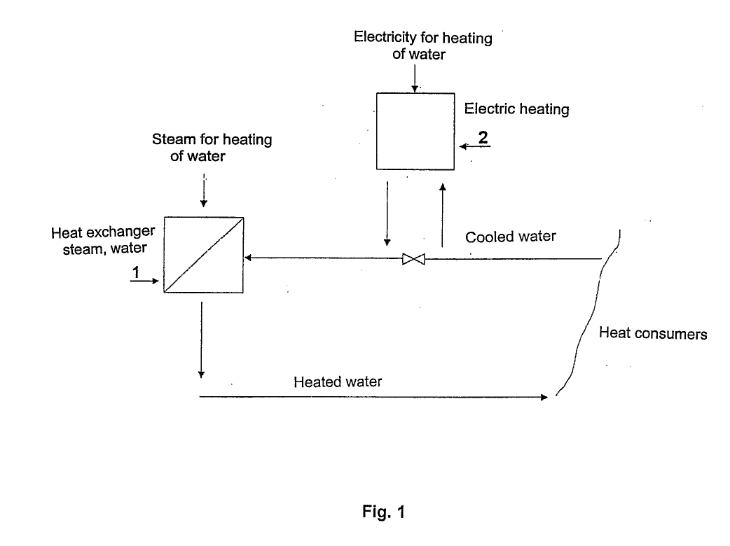

Below, some advantageous embodiments of the invention will be described while one of them is described by reference to the attached FIG. 1 showing the diagram of one of the possible layouts of the electric appliance forming a part of the energy system in accordance with the invention.

### EXAMPLES OF EMBODIMENTS OF THE INVENTION

The electricity grid very often finds itself in the state of electricity surplus with a requirement for output reduction. The equivalent of not produced electricity is consumption of electricity or its destruction. The regulation range of the electricity or electricity and heat production source can be increased by incorporating an electric appliance in that electric system, which thus besides the source also contains this electric appliance. Electric power will not be destroyed, but it will be used for the production of required heat.

The invention uses the combination of heat production with an increase of electricity consumption in heat sources for the production of electricity or electricity and heat (hereinafter also “source” only) while the energy will not be destroyed, but efficiently used.

The increase of internal consumption may be achieved e.g. by starting of electric heating of water or other heat-carrying media supplied to the customers or used for internal needs of the source. This way a part of the electricity will be consumed for the production of heat and at the same time the turbine will be operable in a wider range since it will not get below the minimum output. In this solution of increasing the internal consumption and thus reducing the total output of the energy system below the sustainable level from the turbine point an electric water heater will be connected to the existing steam or hot-water heat exchanger (hereinafter also “exchanger” only) used to heat heating water. The layout and particular design of the water heater will depend on every particular source. There are limiting factors as the layout of the source, parameters of the heating media, specifics of the local heat market, etc.

If there is a requirement for a sudden reduction of the electric output from the energy system below the regulation range of the turbine at a particular moment (the regulation range is also derived from current heat supplies), cooled water returned from the customers will be heated in an electric boiler or with a heating coil installed directly in the pipeline or another flow place before entering the heat exchanger. Water flowing to the customers can be additionally heated in a similar way. The flow through the exchanger will be maintained, steam consumption for heating of water will be controlled in accordance with the additional heating for the needs of high-quality supply of heat to end customers. A diagram of one of possible ways of connection is shown in FIG. 1.

The electric boiler may be designed as a through-flow boiler with a large heating surface and will be connected to the source as a part of the energy system. During operation with the exchanger only (without a requirement to increase internal consumption of electricity) the electric boiler will be separated from the technology without any influence on the operation of the source. To eliminate the pressure loss of water due to its flow through the electric boiler in the case of its use the output of the circulation pumps of heating water may be increased. For the regulation of flow through the electric boiler a closing valve may be installed that will influence the flow through the electric boiler by setting the pressure proportions. The electric boiler may also be equipped with technology for the protection of the heating surface from operation without the cooling media.

The layout where not all the returned water from the customers, but only its part will flow will work in the same way. In such a case there will also be a system of closures to separate the newly installed equipment.

The described design of the electric boiler is one of many technically possible ways of increasing the internal consumption of electricity to influence the total output of the energy system and consequently the scope of supporting services.

As shown above, the main advantage and characteristic feature of the method and energy system based on the present invention as compared to the hitherto state of the art is the fact that the proposed energy system (and method) allows you to reduce the electric output in the place of connection to the electricity grid as compared to the electric output provided by the source alone by increasing the consumption of electricity while electricity is used efficiently for the purpose of heat supply. Compared to simple destruction of energy or a total shutdown of the source this solution besides increasing the regulation range also ensures efficient use of energy in the fuel and is more environment-friendly.

1. A method of extension of the regulation range of the electric power in which electricity produced by an electricity or electricity and heat production source can be supplied in the place of connection to the electricity grid, where the regulation range of the source is limited by the maximum installed electric output at the top and the minimum electric output of the source at which it is still possible to operate the source in a stable way at the bottom, characterized in that before the place of connection to the electricity grid an electric appliance is installed to the source and the electric appliance will reduce the electric output in the place of connection to the electricity grid below the minimum electric output of the source through its own consumption if needed, extending the regulation range of the electric output that can be supplied to the electricity grid in the place of connection as compared to the regulation range of the source alone.

2. The method according to claim 1, characterized in that as the electric appliance an electric heater of heat-carrying media is installed.

3. The method according to claim 2, characterized in that an electric water heater (2) is connected to the steam or hot-water heat exchanger (1) of the source designed to heat water by steam, wherein in the case of a requirement to reduce the electric output in the place of connection to the electricity grid below the minimum electric output of the source water will be heated in the electric water heater (2).

4. The method according to claim 3, characterized in that in the electric water heater (2) at least a part of cooled water returned from the heat consumer (s) is heated before it enters the heat exchanger (1).

5. The method according to claim 3, characterized in that in the electric water heater (2) at least a part of water flowing to the heat consumer (s) from the heat exchanger (1) is additionally heated.

6. An energy system with an extended regulation range of electric power in which electricity produced by an electricity or electricity and heat production source can be supplied in the place of connection to the electricity grid, where the regulation range of the source is limited by the maximum installed electric output at the top and the minimum electric output of the source at which it is still possible to operate the source in a stable way at the bottom, characterized in that it comprises an electric appliance installed to the source before the place of connection to the electricity grid.

7. The energy system according to claim 6, characterized in that the electric appliance is an electric heater of heat-carrying media.

8. The energy system in accordance with claim 7, characterized in that to the steam or hot-water heat exchanger (1) of the source designed to heat water an electric water heater (2) is installed to reduce, in the case of need, the electric output in the place of connection to the electricity grid below the minimum electric output of the source.

9. The energy system according to claim 8, characterized in that the electric water heater (2) is designed to heat at least a part of cooled water returned from the heat consumer (s) before it enters the heat exchanger (1).

10. The energy system according to claim 8, characterized in that the electric water heater (2) is designed to additionally heat at least a part of water flowing to the heat consumer (s) from the heat exchanger (1).
